(19) United States
(12) Patent Application Publication
(10) Pub. No.: US 2026/0075650 A1
(43) Pub. Date: Mar. 12, 2026

(54) DATA TRANSMISSION METHOD AND APPARATUS THEREOF

(71) Applicant: MEDIATEK INC., Hsinchu City (TW)

(72) Inventor: Chia-Shun WAN, Hsinchu City (TW)

(21) Appl. No.: 18/883,575

(22) Filed: Sep. 12, 2024

(51) Int. Cl. H04W 74/0816; H04L 5/00; H04W 76/18

(52) U.S. Cl. CPC H04W 74/0816; H04L 5/003; H04W 76/18

(57) ABSTRACT

An initiator apparatus is provided. The initiator apparatus may include a transceiver and a processor. The transceiver may be configured to perform wireless transmission and reception to and from a responder apparatus. The processor may be coupled to the transceiver. The processor may perform the following operations. The processor may transmit, via the transceiver, a request to send (RTS) frame to the responder apparatus for a transmission opportunity (TXOP) burst during a TXOP duration of a TXOP operation, wherein the RTS frame indicates whether a preempt operation is allowable during the TXOP duration. The processor may also determine to suspend the TXOP operation in the event that the initiator apparatus does not receive a clear-to-send (CTS) frame corresponding to the RTS frame from the responder apparatus.

### BACKGROUND OF THE INVENTION

### Field of the Invention

The invention generally relates to wireless communications technology, and more particularly, to data transmission for transmission opportunity (TXOP) operation.

### Description of the Related Art

As demand for ubiquitous computing and networking has grown, various wireless technologies have been developed, including Wireless-Fidelity (Wi-Fi) which is a Wireless Local Area Network (WLAN) technology allowing mobile devices (such as smartphones, smart pads, laptop computers, portable multimedia players, embedded apparatuses, and the like) to obtain wireless services in a frequency band of 2.4 GHz, 5 GHz, 6Gz or 60 GHz.

The Institute of Electrical and Electronics Engineers (IEEE) has commercialized or developed various technological standards since an initial WLAN technology is supported using frequencies of 2.4 GHz. For example, IEEE 802.11ac supports Multi-User (MU) transmission using spatial degrees of freedom via a MU-Multiple Input-Multiple-Output (MU-MIMO) scheme in a downlink (DL) direction from an Access Point (AP) to Stations (STAs). To improve performance and meet users'demand for high-capacity and high-rate services, IEEE 802.11ax has been proposed, which uses both Orthogonal Frequency Division Multiple Access (OFDMA) and MU-MIMO in both DL and uplink (UL) directions. That is, in addition to supporting frequency and spatial multiplexing from an AP to multiple STAs, transmissions from multiple STAs to the AP are also supported in IEEE 802.11ax.

In the conventional technologies, when an access category (AC) traffic with higher priority needs to be performed while a TXOP burst for an AC with lower priority is being performed during the TXOP duration, the AC traffic with higher priority may have opportunity to compete the medium (or channel) until the TXOP burst for the AC with lower priority has been completed. Therefore, the latency of the AC traffic with higher priority will be too long.

Therefore, how to reduce the latency of the AC traffic with higher priority in the TXOP operation is a topic that is worthy of discussion.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to preempt mechanism for transmission opportunity (TXOP) operation with respect to user equipment and network apparatus in mobile communications. It is believed that the above-described issue would be avoided or otherwise alleviated by implementing one or more of the proposed schemes described herein.

An embodiment of the invention provides an initiator apparatus. The initiator apparatus may include a transceiver and a processor. The transceiver may be configured to perform wireless transmission and reception to and from a responder apparatus. The processor may be coupled to the transceiver. The processor may perform the following operations. The processor may transmit, via the transceiver, a request to send (RTS) frame to the responder apparatus for a transmission opportunity (TXOP) burst during a TXOP duration of a TXOP operation, wherein the RTS frame indicates whether a preempt operation is allowable during the TXOP duration. The processor may also determine to suspend the TXOP operation in the event that the initiator apparatus does not receive a clear-to-send (CTS) frame corresponding to the RTS frame from the responder apparatus.

In some embodiments, the processor may receive, via the transceiver, a block acknowledgement (BA) frame from the responder apparatus after transmitting a data frame to the responder apparatus. The BA frame may indicates whether the preempt operation is allowable during the TXOP duration in the event that the initiator apparatus is a station (STA) and the responder apparatus is an access point (AP).

In some embodiments, there may be a short inter-frame space (SIFS) between the TXOP burst and the next TXOP burst during the TXOP duration.

In some embodiments, the processor may transmit, via the transceiver, the RTS frame to the responder apparatus for the next TXOP burst during the TXOP duration after the SIFS.

In some embodiments, the RTS frame may comprise a bit or a flag to indicate whether the preempt operation is allowable during the TXOP duration.

In some embodiments, the processor may receive, via the transceiver, an abort frame from the responder apparatus after transmitting the RTS frame to the responder apparatus, and suspend the TXOP operation.

In some embodiments, in the event that the CTS frame is interfered with by an abort frame from a station (STA), the CTS frame may be not received by the initiator apparatus successfully.

In some embodiments, in the event that the RTS frame is interfered with by an abort frame from a station (STA), the RTS frame may be not transmitted to the responder apparatus successfully, and the initiator apparatus may not receive the CTS frame from the responder apparatus.

An embodiment of the invention provides a station STA. The STA may include a transceiver and a processor. The transceiver may be configured to perform wireless transmission and reception to and from a responder apparatus. The processor may be coupled to the transceiver. The processor may perform the following operations. The processor may receive, via the transceiver, a request to send (RTS) frame or a block acknowledgement (BA) frame from an access point (AP) for a transmission opportunity (TXOP) burst during a TXOP duration of a TXOP operation, wherein the RTS frame and the BA frame indicate whether a preempt operation is allowable during the TXOP duration. The processor may also determine whether to perform the preempt operation according to the RTS frame or the BA frame.

An embodiment of the invention provides a data transmission method. The data transmission method may be applied to a station (STA). The data transmission method includes the following steps. The STA may receive a request to send (RTS) frame or a block acknowledgement (BA) frame from an access point (AP) for a transmission opportunity (TXOP) burst during a TXOP duration of a TXOP operation, wherein the RTS frame and the BA frame indicate whether a preempt operation is allowable during the TXOP duration. The STA may also determine whether to perform the preempt operation according to the RTS frame or the BA frame.

Other aspects and features of the invention will become apparent to those with ordinary skill in the art upon review of the following descriptions of specific embodiments of the data transmission methods and apparatus.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus according to an embodiment of the application.

FIG. 3 is a block diagram illustrating a network node according to an embodiment of the application.

FIG. 4 is a schematic diagram illustrating a preempt operation according to an embodiment of the application.

FIG. 5 is a schematic diagram illustrating a preempt operation according to another embodiment of the application.

FIG. 6 is a schematic diagram illustrating a preempt operation according to another embodiment of the application.

FIG. 7 is a flow chart illustrating a data transmission method according to an embodiment of the invention.

### DETAILED DESCRIPTION OF THE DISCLOSURE

The following description is of the best-contemplated mode of carrying out the invention. This description is made for the purpose of illustrating the general principles of the invention and should not be taken in a limiting sense. The scope of the invention is best determined by reference to the appended claims.

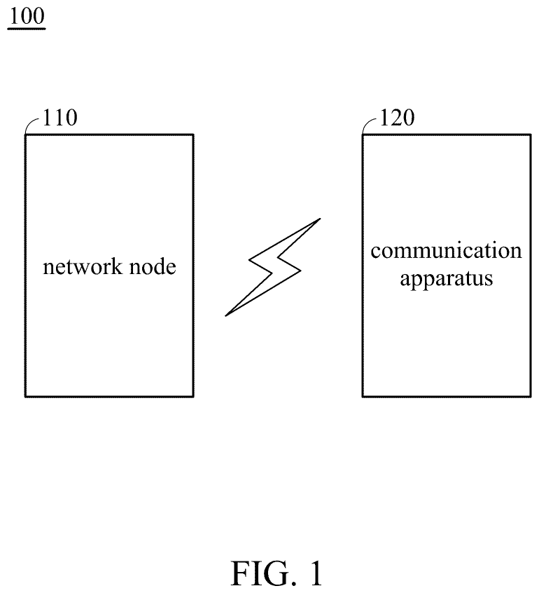

FIG. 1 is a block diagram of a wireless communication system 100 according to an embodiment of the application. As shown in FIG. 1, the wireless communication system 100 may include a network node 110 and a communication apparatus 120. It should be noted that, in order to clarify the concept of the invention, FIG. 1 presents a simplified block diagram in which only the elements relevant to the invention are shown. However, the invention should not be limited to what is shown in FIG. 1.

In an embodiment of the invention, the network node 110 may be an access point (AP). In an example, the network node 110 may be an Extremely High Throughput (EHT) AP which is compatible with the IEEE 802.11be standards. In another embodiment of the invention, the network node 110 may be an AP which is compatible with any IEEE 802.11 standards later than 802.11be.

In the embodiments of the invention, the communication apparatus 120 may be may be user equipment (UE), a non-AP station (STA), a mobile phone (e.g., feature phone or smartphone), a panel Personal Computer (PC), a laptop computer, or any computing device, as long as it is compatible with the same IEEE 802.11 standards as the network node 110. The communication apparatus 120 may associate and communicate with the network node 110 to send or receive data in an uplink (UL) or downlink (DL) Multi-User-Physical layer Protocol Data Unit (MU-PPDU). The MU-PPDU may be a resource-unit Orthogonal Frequency Division Multiple Access (RU-OFDMA), a MU-Multiple Input-Multiple-Output (MU-MIMO) PPDU, or an aggregated PPDU.

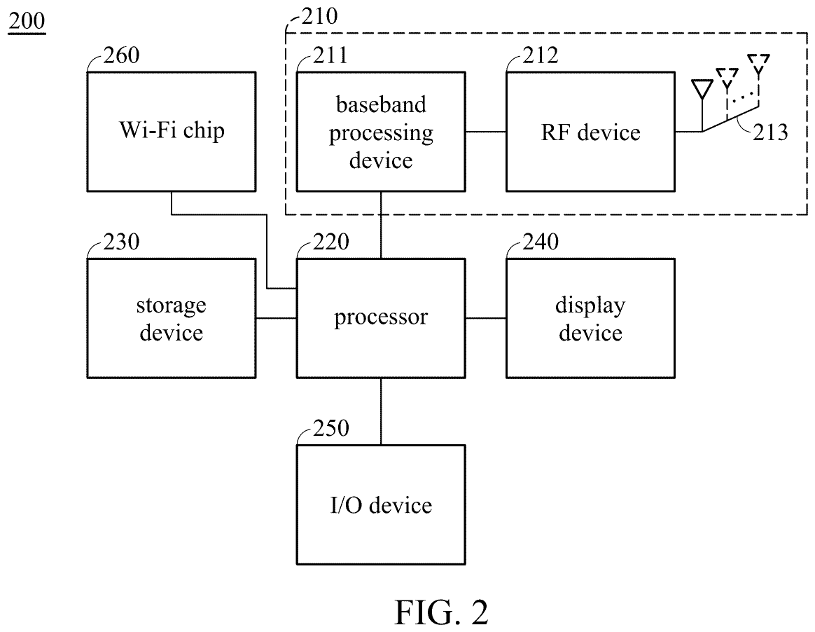

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a wireless transceiver 210, a processor 220, a storage device 230, a display device 240, an Input/Output (I/O) device 250, and a Wi-Fi chip 260.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, the I/O device 250, and the Wi-Fi chip 260 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

According to an embodiment of the invention, the Wi-Fi chip 260 may comprise Wi-Fi antenna and may be configured to perform the operations of Wi-Fi communications.

According to an embodiment of the invention, the wireless transceiver 210 may be configured in a modem (MD) of the communication apparatus 200, and the processor 220 may be configured in an application processor (AP) of the communication apparatus 200.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

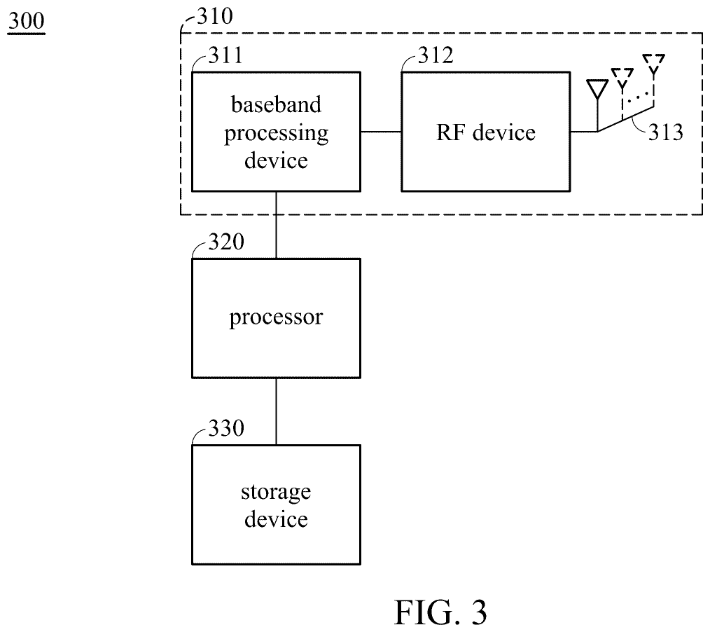

FIG. 3 is a block diagram illustrating a network node 300 according to an embodiment of the application. The network node 300 can be applied to the network node 110. As shown in FIG. 3, the network node 300 may comprise a wireless transceiver 310, a processor 320, and a storage device 330.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPH/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

According to an embodiment of the invention, in a transmission opportunity (TXOP) operation, an initiator apparatus (e.g., network node 110 (or communication apparatus 120)) may transmit a request to send (RTS) frame to a responder apparatus (e.g., communication apparatus 120 (or network node 110)) for a TXOP burst during a TXOP duration. When the responder apparatus receives the RTS frame from the initiator apparatus, the responder apparatus may transmit a clear-to-send (CTS) frame to the initiator apparatus to respond to the RTS frame. Then, the initiator apparatus may transmit a data frame (e.g., a physical layer protocol data unit (PPDU)). When the responder apparatus successfully receives the data frame from the initiator apparatus, the responder apparatus may transmit a block acknowledgement (BA) frame to the initiator apparatus.

According to an embodiment of the invention, in the TXOP operation, for each TXOP burst, the initiator apparatus may need to transmit the RTS frame to the responder apparatus, and the responder apparatus may need to transmit the CTS frame to respond to the RTS frame.

In addition, according to an embodiment of the invention, there may be a plurality of TXOP bursts during the TXOP duration, and there may be a short inter-frame space (SIFS) between a TXOP burst and its next TXOP burst during the TXOP duration. That is, in the embodiments of the invention, for the preempt operation, the duration between the TXOP bursts may not be extended.

In addition, according to an embodiment of the invention, the airtime of the data frame in each TXOP burst may be shorter than a target latency require time (TBD) (e.g., 1. 5 millisecond (ms)) to avoid the latency of the access category (AC) traffic with higher priority is too long.

According to an embodiment of the invention, the RTS frame may indicate whether a preempt operation is allowable during the TXOP duration. In an example, the RTS frame may comprise a bit or a flag to indicate whether the preempt operation is allowable during the TXOP duration. The bit may be a reserve bit of a physical (PHY) preamble or a medium access control (MAC) header of the RTS frame. For example, if the bit or the flag is a first value (e.g., “1”), the RTS frame may indicate that the preempt operation is allowable during the TXOP duration, but the invention should not be limited thereto. When the responder apparatus (or another STA in the same basic service set (BSS), i.e., intra-BSS) receives the RTS frame indicating that the preempt operation is allowable during the TXOP duration, the responder apparatus (or another STA in the same BSS) may know that the preempt operation can be allowable during the TXOP duration. When the preempt operation is allowable during the TXOP duration, the responder apparatus (or another STA in the same BSS i.e., intra-BSS) may be transmit an abort frame (e.g., a CfEnd frame) to trigger the preempt operation for the AC traffic with higher priority.

In addition, according to an embodiment of the invention, when the initiator apparatus is a STA and the responder apparatus is an AP, the BA frame may further indicate whether the preempt operation is allowable during the TXOP duration. The BA frame may also comprise a bit or a flag to indicate whether the preempt operation is allowable during the TXOP duration. That is, in the embodiment, when another STA in the same BSS as the initiator apparatus receives the BA frame indicating that the preempt operation is allowable during the TXOP duration, this STA may know that the preempt operation can be allowable during the TXOP duration.

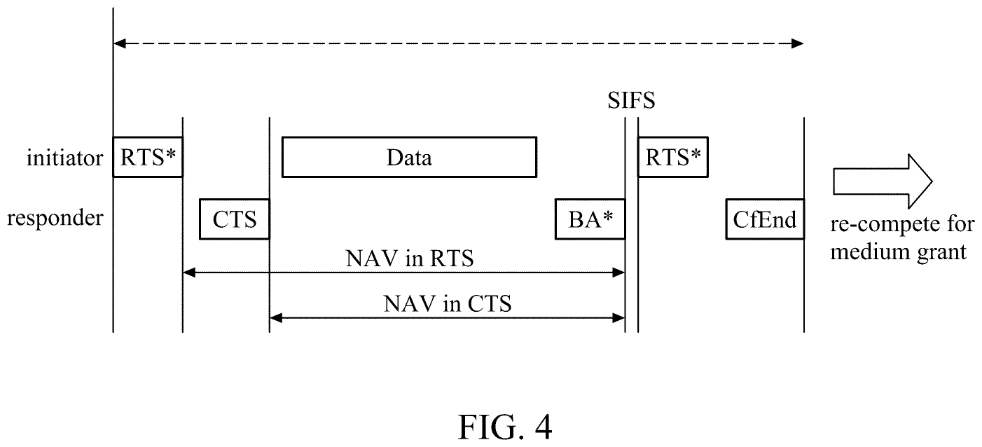

According to an embodiment of the invention, the initiator apparatus may determine to suspend the TXOP operation when the initiator apparatus does not successfully receive a CTS frame corresponding to the RTS frame from the responder apparatus. Details for the embodiment may be discussed below by referring to FIGS. 4-6.

FIG. 4 is a schematic diagram illustrating a preempt operation according to an embodiment of the application. The preempt operation of FIG. 4 may be applied in an initiator apparatus and a responder apparatus. The initiator apparatus and the responder apparatus may be an AP and an STA respectively, or the initiator apparatus and the responder apparatus may be an STA and an AP respectively. As shown in FIG. 4, the initiator apparatus may transmit the RTS frame (i.e., RTS*) to the indicate that the preempt operation is allowable during the TXOP duration. In addition, as shown in FIG. 4, after the initiator apparatus transmits the data frame to the responder apparatus, the responder apparatus may transmit a BA frame (i.e., BA*) to the initiator apparatus, wherein the BA frame may also indicate that the preempt operation is allowable during the TXOP duration. In addition, the RTS frame and the CTS frame may have its corresponding network allocation vector (NAV) time respectively. When the responder apparatus needs to transmit the access category (AC) traffic with higher priority during the TXOP duration (i.e., the preempt operation needs to be performed), after receiving the RTS frame from the initiator apparatus, the responder apparatus may transmit an abort frame (e.g., a CfEnd frame) to the initiator apparatus rather than transmitting normal CTS frame corresponding to the RTS frame to the initiator apparatus to perform a preempt operation for the AC traffic with higher priority. That is, in the embodiment, in the preempt operation, the initiator apparatus may only receive the abort frame (e.g., a CfEnd frame) from the responder apparatus, but does not successfully receive a normal CTS frame corresponding to the RTS frame from the responder apparatus. Therefore, the initiator apparatus may determine to suspend the TXOP operation (i.e., the medium can be competed again). Then, the responder apparatus may perform a backoff procedure. Because the AC traffic with higher priority may correspond to stronger backoff parameter (e.g., shorter backoff time), in the backoff procedure, the AC traffic with higher priority may have higher probability to compete the medium (channel).

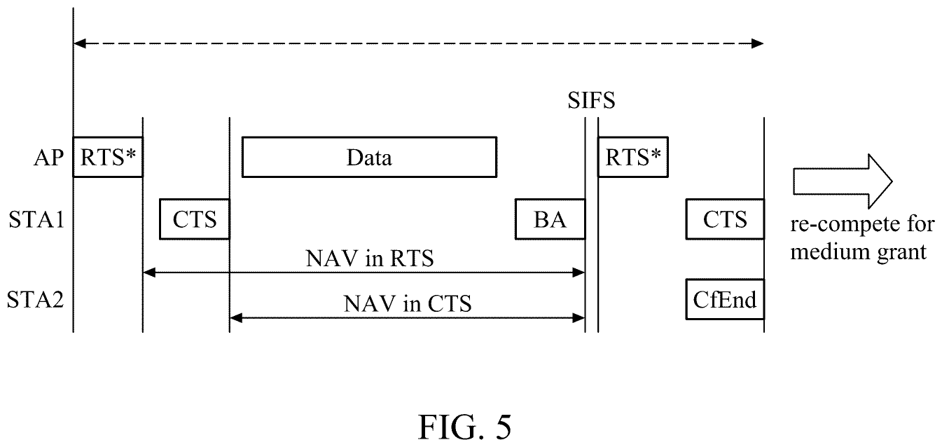

FIG. 5 is a schematic diagram illustrating a preempt operation according to another embodiment of the application. The preempt operation of FIG. 5 may be applied in an initiator apparatus, a responder apparatus and another STA (i.e., STA 2) in the intra-BSS. The initiator apparatus and the responder apparatus may be an AP and an STA (i.e., STA 1) respectively. As shown in FIG. 5, the AP may transmit the RTS frame (i.e., RTS*) to the STA 1 to indicate that the preempt operation is allowable during the TXOP duration. Both of the STA 1 and STA 2 in the same BSS corresponding to the AP can receive the RTS frame (i.e., RTS*). In addition, in the embodiment, the BA frame (i.e., BA) from the STA 1 may not need to indicate that the preempt operation is allowable during the TXOP duration. In addition, the RTS frame and the CTS frame may have its corresponding NAV time respectively. When STA 2 needs to transmit the access category (AC) traffic with higher priority during the TXOP duration (i.e., the preempt operation needs to be performed), the STA 2 may transmit an abort frame (e.g., a CfEnd frame) while the STA 1 transmit the CTS frame to the AP to perform the preempt operation. The CTS frame from the STA 1 may be interfered with by the abort frame (i.e., a collision between the CTS frame and abort frame may occur). Therefore, the AP may not receive the CTS frame from the STA 1 successfully. Therefore, the AP may determine to suspend the TXOP operation (i.e., the medium can be competed again) since it does not successfully receive CTS frame from the STA 1. Then, the STA 2 may perform a backoff procedure. Because the AC traffic with higher priority may correspond to stronger backoff parameter (e.g., shorter backoff time), in the backoff procedure, the AC traffic with higher priority may have higher probability to compete the medium (channel).

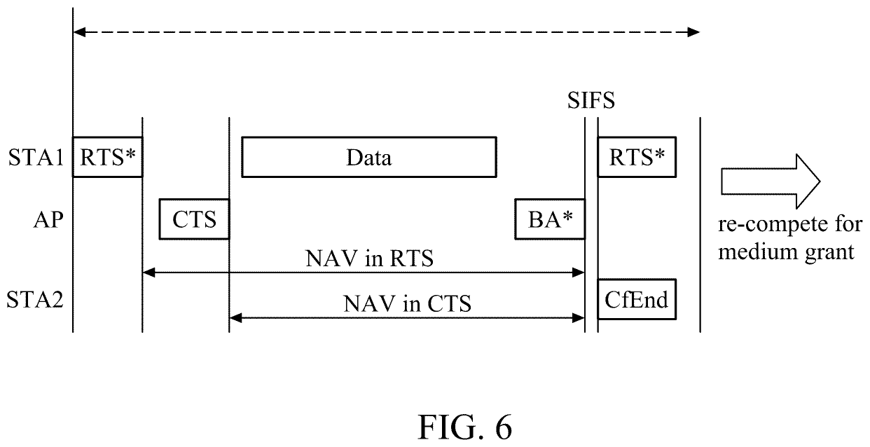

FIG. 6 is a schematic diagram illustrating a preempt operation according to another embodiment of the application. The preempt operation of FIG. 6 may be applied in an initiator apparatus, a responder apparatus and another STA (i.e., STA 2) in the intra-BSS. The initiator apparatus and the responder apparatus may be an STA (i.e., STA 1) and an AP respectively. As shown in FIG. 6, the STA 1 may transmit the RTS frame (i.e., RTS*) to the AP to indicate that the preempt operation is allowable during the TXOP duration. In addition, after the AP receives the data frame from the STA 1, the AP may transmit a BA frame (i.e., BA*) to the STA 1. The BA frame from the AP may also indicate that the preempt operation is allowable during the TXOP duration. Bothe of the STA 1 and STA 2 in the same BSS corresponding to the AP can receive the BA frame (i.e., BA*). In addition, the RTS frame and the CTS frame may have its corresponding NAV time respectively. When STA 2 needs to transmit the access category (AC) traffic with higher priority during the TXOP duration (i.e., the preempt operation needs to be performed), the STA 2 may transmit an abort frame (e.g., a CfEnd frame) while the STA 1 transmit the RTS frame (i.e., RTS*) to the AP to perform the preempt operation. That is, the RTS frame (i.e., RTS*) may be interfered with by the abort frame. Therefore, the AP may not receive the RTS frame (i.e., RTS*) from the STA 1 successfully, and also not transmit the CTS frame corresponding to RTS frame (i.e., RTS*) to the STA 1. Therefore, the STA 1 may determine to suspend the TXOP operation (i.e., the medium can be competed again) since it does not successfully receive CTS frame from the AP. Then, the STA 2 may perform a backoff procedure. Because the AC traffic with higher priority may correspond to stronger backoff parameter (e.g., shorter backoff time), in the backoff procedure, the AC traffic with higher priority may have higher probability to compete the medium (channel). It should be noted that, in the embodiment, the STA 2 can know that the preempt operation is allowable during the TXOP duration according to the BA frame (i.e., BA*) from the AP. Therefore, even if the STA 1 and STA 2 are hidden node each other, the STA 2 also can know that the abort frame (e.g., a CfEnd frame) may abort the RTS frame (i.e., RTS*) from the STA 1 (i.e., the RTS frame may be interfered with by the abort frame) to make the AP cannot receive the RTS frame (i.e., RTS*) from the STA 1 normally.

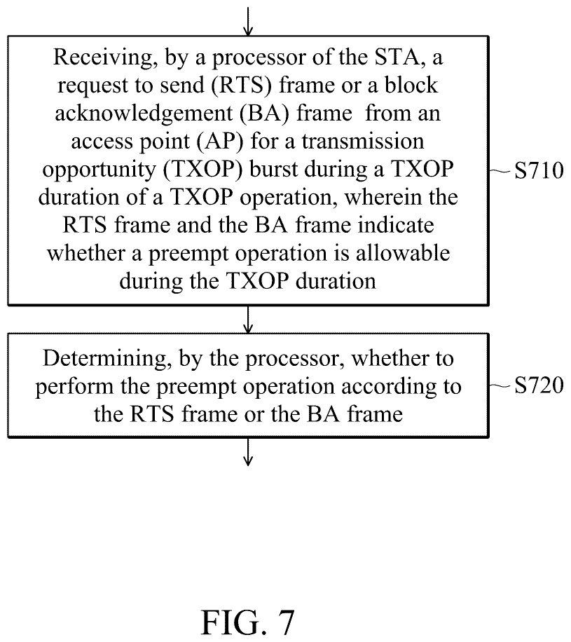

FIG. 7 is a flow chart illustrating a data transmission method according to an embodiment of the invention. The data transmission method can be applied to an STA (e.g., the communication apparatus 120 of the wireless communication system 100). As shown in FIG. 7, in step S710, the STA may receive an RTS frame or a BA frame from an AP for a TXOP burst during a TXOP duration of a TXOP operation. The RTS frame and the BA frame may indicate whether a preempt operation is allowable during the TXOP duration.

In step S720, the STA may determine whether to perform the preempt operation according to the RTS frame or the BA frame.

According to an embodiment of the invention, in the data transmission method, the RTS frame or the BA frame may comprise a bit or a flag to indicate whether the preempt operation is allowable during the TXOP duration.

According to an embodiment of the invention, in the data transmission method, when the AP is an initiator apparatus and the STA is a responder apparatus, the STA may receive the RTS frame from the AP for the TXOP burst during the TXOP duration, and transmit an abort frame to the AP to perform the preempt operation after receiving the RTS frame from the AP in the event that the RTS frame indicates that the preempt operation is allowable during the TXOP duration.

According to an embodiment of the invention, in the data transmission method, when the AP is an initiator apparatus and the STA is not a responder apparatus, the STA may receive the RTS frame from the AP for the TXOP burst during the TXOP duration, and transmit an abort frame to interfere with a CTS frame corresponding to the RTS frame from the responder apparatus to perform the preempt operation in the event that the RTS frame indicates that the preempt operation is allowable during the TXOP duration.

According to an embodiment of the invention, in the data transmission method, when the AP is a responder apparatus and the STA is not an initiator apparatus, the STA may receive the BA frame from the AP for the TXOP burst during the TXOP duration, and transmit an abort frame to interfere with the RTS frame from the initiator apparatus to perform the preempt operation in the event that the BA frame indicates that the preempt operation is allowable during the TXOP duration.

According to an embodiment of the invention, in the data transmission method, there is a SIFS between the TXOP burst and the next TXOP burst during the TXOP duration.

According to the data transmission method provided in the embodiments of the invention, when the AC traffic with higher priority needs to be transmitted during the TXOP duration for the AC traffic with lower priority, the TXOP operation can be suspended for the preempt operation for the AC traffic with higher priority. Therefore, the latency of the AC traffic with higher priority will be reduced.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An initiator apparatus, comprising:
a transceiver, configured to perform wireless transmission and reception to and from a responder apparatus; and
a processor, coupled to the transceiver, and performing operations comprising:
transmitting, via the transceiver, a request to send (RTS) frame to the responder apparatus for a transmission opportunity (TXOP) burst during a TXOP duration of a TXOP operation, wherein the RTS frame indicates whether a preempt operation is allowable during the TXOP duration; and
determining to suspend the TXOP operation in an event that the initiator apparatus does not receive a clear-to-send (CTS) frame corresponding to the RTS frame from the responder apparatus.

2. The initiator apparatus of claim 1, wherein the processor performs operations further comprising:
receiving, via the transceiver, a block acknowledgement (BA) frame from the responder apparatus after transmitting a data frame to the responder apparatus,
wherein the BA frame indicates whether the preempt operation is allowable during the TXOP duration in an event that the initiator apparatus is a station (STA) and the responder apparatus is an access point (AP).

3. The initiator apparatus of claim 1, wherein there is a short inter-frame space (SIFS) between the TXOP burst and a next TXOP burst in the TXOP duration.

4. The initiator apparatus of claim 3, wherein the processor performs operations further comprising:
transmitting, via the transceiver, the RTS frame to the responder apparatus for the next TXOP burst during the TXOP duration after the SIFS.

5. The initiator apparatus of claim 1, wherein the RTS frame comprises a bit or a flag to indicate whether the preempt operation is allowable during the TXOP duration.

6. The data transmission method of claim 1, wherein the processor performs operations further comprising:
receiving, via the transceiver, an abort frame from the responder apparatus after transmitting the RTS frame to the responder apparatus; and
suspending the TXOP operation.

7. The data transmission method of claim 1, wherein in an event that the CTS frame is interfered with by an abort frame from a station (STA), the CTS frame is not received by the initiator apparatus successfully.

8. The data transmission method of claim 1, wherein in an event that the RTS frame is interfered with by an abort frame from a station (STA), the RTS frame is not transmitted to the responder apparatus successfully, and the initiator apparatus does not receive the CTS frame from the responder apparatus.

9. A station (STA), comprising:
a transceiver, configured to perform wireless transmission and reception to and from a responder apparatus; and
a processor, coupled to the transceiver, and performing operations comprising:
receiving, via the transceiver, a request to send (RTS) frame or a block acknowledgement (BA) frame from an access point (AP) for a transmission opportunity (TXOP) burst during a TXOP duration of a TXOP operation, wherein the RTS frame and the BA frame indicate whether a preempt operation is allowable during the TXOP duration; and
determining whether to perform the preempt operation according to the RTS frame or the BA frame.

10. The STA of claim 9, wherein the RTS frame or the BA frame comprises a bit or a flag to indicate whether the preempt operation is allowable during the TXOP duration.

11. The STA of claim 9, wherein in an event that the AP is an initiator apparatus and the STA is a responder apparatus, the processor performs operations comprising:
receiving, via the transceiver, the RTS frame from the AP for the TXOP burst during the TXOP duration; and
transmitting, via the transceiver, an abort frame to the AP to perform the preempt operation after receiving the RTS frame from the AP in an event that the RTS frame indicates that the preempt operation is allowable during the TXOP duration.

12. The STA of claim 9, wherein in an event that the AP is an initiator apparatus and the STA is not a responder apparatus, the processor performs operations comprising:
receiving, via the transceiver, the RTS frame from the AP for the TXOP burst during the TXOP duration; and
transmitting, via the transceiver, an abort frame to interfere with a clear-to-send (CTS) frame corresponding to the RTS frame from the responder apparatus to perform the preempt operation in an event that the RTS frame indicates that the preempt operation is allowable during the TXOP duration.

13. The STA of claim 9, wherein in an event that the AP is a responder apparatus and the STA is not an initiator apparatus, the processor performs operations comprising:
receiving, via the transceiver, the BA frame from the AP for the TXOP burst during the TXOP duration; and
transmitting, via the transceiver, an abort frame to interfere with the RTS frame from the initiator apparatus to perform the preempt operation in an event that the BA frame indicates that the preempt operation is allowable during the TXOP duration.

14. The STA of claim 9, wherein there is a short inter-frame space (SIFS) between the TXOP burst and a next TXOP burst during the TXOP duration.

15. A data transmission method, applied to a station (STA), comprising:
receiving, by a processor of the STA, a request to send (RTS) frame or a block acknowledgement (BA) frame from an access point (AP) for a transmission opportunity (TXOP) burst during a TXOP duration of a TXOP operation, wherein the RTS frame and the BA frame indicate whether a preempt operation is allowable during the TXOP duration; and
determining, by the processor, whether to perform the preempt operation according to the RTS frame or the BA frame.

16. The data transmission method of claim 15, wherein the RTS frame or the BA frame comprises a bit or a flag to indicate whether the preempt operation is allowable during the TXOP duration.

17. The data transmission method of claim 15, wherein in an event that the AP is an initiator apparatus and the STA is a responder apparatus, the method comprises:
receiving, by the processor, the RTS frame from the AP for the TXOP burst during the TXOP duration; and
transmitting, by the processor, an abort frame to the AP to perform the preempt operation after receiving the RTS frame from the AP in an event that the RTS frame indicates that the preempt operation is allowable during the TXOP duration.

18. The data transmission method of claim 15, wherein in an event that the AP is an initiator apparatus and the STA is not a responder apparatus, the method comprises:
receiving, by the processor, the RTS frame from the AP for the TXOP burst during the TXOP duration; and
transmitting, by the processor, an abort frame to interfere with a clear-to-send (CTS) frame corresponding to the RTS frame from the responder apparatus to perform the preempt operation in an event that the RTS frame indicates that the preempt operation is allowable during the TXOP duration.

19. The data transmission method of claim 15, wherein in an event that the AP is a responder apparatus and the STA is not an initiator apparatus, the method comprises:
receiving, by the processor, the BA frame from the AP for the TXOP burst during the TXOP duration; and
transmitting, by the processor, an abort frame to interfere with the RTS frame from the initiator apparatus to perform the preempt operation in an event that the BA frame indicates that the preempt operation is allowable during the TXOP duration.

20. The data transmission method of claim 15, wherein there is a short inter-frame space (SIFS) between the TXOP burst and a next TXOP burst during the TXOP duration.
